(19) United States
(12) Patent Application Publication
(10) Pub. No.: US 2009/0100063 A1
(43) Pub. Date: Apr. 16, 2009

(54) SYSTEM AND METHOD FOR OBTAINING LOCATION INFORMATION USING A NETWORKED PORTABLE ELECTRONIC DEVICE

(76) Inventors: Henrik Bengtsson, Lund (SE); Tsuyoshi Masuzawa, Limhamn (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/870,011

(22) Filed: Oct. 10, 2007

(51) Int. Cl. G06F 17/30

(52) U.S. Cl. 707/10

(57) ABSTRACT

An improved system and method is disclosed for providing a user with detailed information about a particular location where the user is present. In one embodiment, a user may take a video of the location where the user is present. The user's video may be transmitted to a network server, which performs a video recognition algorithm to match the video to a location about which information is contained in a location information database. The user may then be connected to a network dataset, such as a webpage or webpages, associated with the location. In other embodiments, locality information comprising location identifiers may be obtained or transmitted from the location to a user's portable electronic device. The locality information may be transmitted to a network server, which matches the locality information against a location information database to identify the location. Once the user's location is matched to location information within the database, detailed information about the location may be transmitted directly to the user's portable electronic device.

### TECHNICAL FIELD OF THE INVENTION

The technology of the present disclosure relates generally to portable electronic devices, and more particularly to a system and method for obtaining location information using a networked portable electronic device.

### DESCRIPTION OF THE RELATED ART

Portable electronic devices, such as mobile telephones, media players, personal digital assistants (PDAs), and others, are ever increasing in popularity. It is common for a user of portable electronic devices to have one available nearly at all times. With the ever increasing use, it would be beneficial to be able to receive detailed information about a user's location directly to a portable electronic device. There currently appears to be no convenient method to do so.

To avoid having to carry multiple devices, portable electronic devices are now being configured to provide a wide variety of functions. For example, a mobile telephone may no longer be used simply to make and receive telephone calls. A mobile telephone may also be a camera (still and/or video), an Internet browser for accessing news and information, an audiovisual media player, a messaging device (text, audio, and/or visual messages), a gaming device, a personal organizer, and have other functions as well. Mobile telephones and other portable electronic devices also may be equipped with a location finder function, such as a GPS.

The use of a headset in conjunction with a portable electronic device also is becoming more common. Typically, a headset will be in wireless communication with a portable electronic device, such as a mobile telephone. The wireless interface may be a Bluetooth, RF, infrared, or other short distance wireless interface as are known in the art. Through the headset, one may make and receive telephone calls, or access other device functions, in a “hands free” mode. Hands free usage is particularly beneficial for those who are driving, carrying many objects, or otherwise have limited use of their hands.

As an alternative to a simple audio headset, the use of head mounted displays (HMD) is becoming more common. A typical HMD, as is known in the art, displays information from a portable electronic device directly to the user's eyes. The HMD may be incorporated into a light frame structure with display components similar in configuration to eyeglasses. The HMD permits the user to see regularly while at times displays information to a user. The information may be text, video, pictures, or other images that may be received over an interface from a portable electronic device. The interface may be a wired connection from a video output port of a portable electronic device to an input port on the HMD. The video connection may be VGA, component, digital video interface (DVI), or other connections as are known in the art. Wireless streaming of video from a portable electronic device to an HMD also may be used.

Despite the ever increasing use and functionality of portable electronic devices and HMDs, such devices are not being used to their full potential. Despite the capability of portable electronic devices to cooperate with HMDs to gather and display information, the ability of a user to obtain information about one's location remains deficient. A user would be benefitted by the ability to receive detailed information about a particular location where the user is present.

### SUMMARY

To improve the consumer experience with portable electronic devices, there is a need in the art for an improved system and method for providing a user with detailed information about a particular location where the user is present. In one embodiment, the user may take a video of the location where the user is present. The video may be taken either with a video-equipped portable electronic device or a video camera mounted on an HMD. The user's video may be transmitted to a network server, which performs a video recognition algorithm to match the video to a location about which information is contained in a location information database. The user may then be connected to a network dataset, such as a webpage or webpages, associated with the location. The webpage(s) may be displayed on the display of the portable electronic device or the HMD.

In another embodiment, locality information, such as a name, description of the location (a particular store, monument, etc.) and/or other identifiers associated with the location may be obtained or transmitted from the location to a user's portable electronic device. The locality information may be transmitted to a network server, which matches the locality information against a location information database to identify the location. Once the user's location is matched to location information within the database, detailed information about the location may be transmitted to the portable electronic device. The information may either be displayed on the portable electronic device, or on an HMD.

Therefore, according to one aspect of the invention, a system for obtaining location information comprises a user electronic device comprising a locality information receiver for obtaining locality information, independent of location coordinates data and sufficient to identify a user's location, a location information database containing locality information corresponding to and sufficient to identify a plurality of locations about which information is stored in the database; and a controller configured to compare the locality information for the user's location to the locality information stored on the location information database to determine whether the user's locality information matches the locality information of one of the plurality of locations, wherein if a match is found, the controller causes information about the matched location to be transmitted from the location information database to the user electronic device.

According to one embodiment of the system, the locality information receiver is a video camera and the locality information of the user's location is a video of the location taken with the video camera, the locality information stored on the location information database comprises videos of the plurality of locations about which information is stored in the database, and the controller is configured to perform video recognition to compare the video of the user's location to the videos stored on the location information database to determine whether the user's location matches one of the plurality of locations encompassed by the database.

According to one embodiment of the system, the system further comprises a second user electronic device having a video camera, wherein at least one of the location videos stored on the location information database is a video taken using the second user electronic device.

According to one embodiment of the system, the system further comprises an LED signal transmitter at the user's location, the locality information receiver is an LED signal receiver and the locality information is included in an LED signal transmission received from the LED signal transmitter, the controller is configured to ascertain the locality information from the LED signal transmission to compare the locality information for the user's location to the locality information stored on the location information database.

According to one embodiment of the system, the system further comprises a radio transmitter at the user's location, the locality information receiver is a radio receiver and the locality information is included in a radio transmission received from the radio transmitter, and the controller is configured to ascertain locality information from the radio transmission to compare the locality information for the user's location to the locality information stored on the location information database.

According to one embodiment of the system, the user electronic device further comprises a display for displaying the information transmitted from the location information database.

According to one embodiment of the system, the user electronic device further comprises a browser, and the user electronic device receives information from the location information database by browsing the location information database.

According to one embodiment of the system, the controller is configured to stream information from the location information database to the user electronic device.

According to one embodiment of the system, the system further comprises a server remote from the user electronic device, and the server contains at least one of the location information database and the controller.

According to one embodiment of the system, the user electronic device comprises a portable electronic device.

According to one embodiment of the system, the user electronic device further comprises a head mounted display in communication with the portable electronic device, and the locality information receiver is mounted on the head mounted display.

According to one embodiment of the system, the portable electronic device is a mobile telephone.

According to one embodiment of the system, the locality information further includes GPS coordinates data.

According to another aspect of the invention, a method of obtaining information with a user electronic device about a location comprises the steps of selecting a location about which information is desired, obtaining locality information, independent of location coordinates data, with the user electronic device sufficient to identify the selected location, comparing the locality information of the selected location with locality information corresponding to a plurality of locations about which information is stored in a location information database to determine whether the locality information of the selected location matches the locality information of one of the plurality of locations, and receiving information with the user electronic device about a matched location from the location information database.

According to one embodiment of the method, locality information is obtained by taking a video of the selected location, and the comparing step is performed by using a video recognition algorithm to determine if the video of the selected location matches a video stored on the location information database of one of the plurality of locations.

According to one embodiment of the method, the locality information is obtained by receiving an LED signal transmission containing the locality information, and the comparing step comprises ascertaining the locality information from the LED signal transmission.

According to one embodiment of the method, the locality information is obtained by receiving a radio transmission containing the locality information, and the comparing step comprises ascertaining the locality information from the radio transmission.

According to one embodiment of the method, the receiving step comprises connecting to a webpage in the location information database containing information about the selected location, and browsing the webpage.

According to one embodiment of the method, the locality information is obtained using a head mounted device.

According to one embodiment of the method, the receiving step comprises receiving a streaming information transmission from the location information database.

According to one embodiment of the method, the method further comprises displaying the received information.

According to one embodiment of the method, the received information is displayed on a head mounted display.

According to another aspect of the invention, a method of providing location information to a user electronic device comprises selecting a plurality of locations about which information may be provided, storing locality information, independent of location coordinates data, for and sufficient to identify each of the plurality of locations on a location information database, receiving locality information from a user electronic device, independent of location coordinates data and sufficient to identify a user's location, comparing the locality information received from the user electronic device with the locality information corresponding to the plurality of locations about which information is stored on the location information database to determine whether the locality information of the user's location matches the locality information of one of the plurality of locations, and transmitting information to the user electronic device about a matched location from the location information database.

According to one embodiment of the method, the transmitting step comprises streaming information about a matched location to the user electronic device.

According to one embodiment of the method, the locality information for the user's location and the plurality of locations about which information is stored on the location information database are videos of the locations, and the comparing step comprises performing a video recognition algorithm to determine whether the user's location matches one of the plurality of locations.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device for use in accordance with an embodiment of the present invention.

FIG. 2 is a schematic block diagram of operative portions of the mobile telephone of FIG. 1.

FIG. 3 is a schematic diagram of a communications system in which the mobile telephone of FIG. 1 may operate.

FIG. 4 is a schematic diagram of operative portions of an exemplary location information server that may be used in accordance with an embodiment of the present invention.

FIG. 5 is a flowchart depicting an exemplary method that may be used to perform network functions in accordance with an embodiment of the present invention.

FIG. 6 is a flowchart depicting an exemplary method that may be used to perform user device functions in accordance with an embodiment of the present invention.

FIGS. 7-8 are exemplary systems of obtaining location information in accordance with embodiments of the present invention.

FIG. 9 is a schematic block diagram of operative portions of an HMD for use in accordance with embodiments of the present invention.

FIG. 10 is a flowchart depicting another exemplary method that may be used to perform network functions in accordance with an embodiment of the present invention.

FIG. 11 is a flowchart depicting another exemplary method that may be used to perform user device functions in accordance with an embodiment of the present invention.

FIGS. 12-13 are additional exemplary systems of obtaining location information in accordance with embodiments of the present invention.

### DETAILED DESCRIPTION OF EMBODIMENTS

The present invention provides a system and method for obtaining location information using a networked portable electronic device. In one embodiment, a user may video the location where the user is present using a video camera function on a portable electronic device. Alternatively, the user may video the location using a video camera mounted on an HMD. The user's video may then be transmitted to a network server having a location information database that contains datasets pertaining to numerous locations. The datasets may be in the form of one or more webpages associated with each location encompassed by the database. The server may perform a video recognition algorithm, as is known in the art, to match the user's video with a location video contained in the location database. The user's location may then be matched to the associated location dataset or webpage. A browser function may be accessed within the portable electronic device, and the user may be connected to the webpage to browse information associated with the location where the user is present. Information from the webpage may be displayed on a display contained on the portable electronic device, or on an HMD.

In alternative embodiments, locality information is obtained or transmitted from the location. Locality information is information sufficient to identify a corresponding location. The locality information may comprise a location identifier independent of a location's coordinates, and may include such items as a name, image, description, and/or other attributes sufficient to identify the location. In this manner, the locality information may be useful to distinguish among locations when numerous locations may be within the user's proximity, such as, for example, when the user is in a shopping mall adjacent to numerous store locations. Similarly, the locality information is specific to distinguish between two locations having the same name or similar description, such as, for example, distinguishing between two locations of a restaurant chain.

In another embodiment, coordinates information, such as GPS coordinates, may be combined with the location identifiers in the locality information to aid identifying the location.

The locality information may be obtained in a variety of means. For example, the user may video the location in a manner comparable to that described above, using a video camera function contained in either a portable electronic device or an HMD. Although the video ordinarily would be specific enough to identify the user's location, in one embodiment the video may be combined with coordinates information, such as, for example, GPS coordinates obtained by a GPS function within the portable electronic device. Alternatively, the location (store, monument, etc) may transmit the locality information to a cooperating receiver in the user's portable electronic device or HMD. The locality information transmission may be in the form of an LED signal transmission, radio transmission, or other transmission as is known in the art.

Once the locality information is obtained or transmitted from the location, the locality information may be transmitted to a network server having a location information database that contains datasets pertaining to numerous locations. The server matches the transmitted locality information against locality information corresponding to the locations encompassed by the location information database. Once the user's location is matched, detailed information about the location may be transmitted directly to the user's portable electronic device. The location information may be displayed on a display contained on the portable electronic device, or on an HMD.

Embodiments of the present invention will now be described with reference to the drawings, wherein like reference numerals are used to refer to like elements throughout. It will be understood that the figures are not necessarily to scale.

The following description is made in the context of a conventional mobile telephone. It will be appreciated that the invention is not intended to be limited to the context of a mobile telephone and may relate to any type of appropriate electronic device, examples of which include a media player, a gaming device, or a desktop or laptop computer. For purposes of the description herein, the interchangeable terms “electronic equipment” and “electronic device” also may include portable radio communication equipment. The term “portable radio communication equipment,” which sometimes hereinafter is referred to as a “mobile radio terminal,” includes all equipment such as mobile telephones, pagers, communicators, electronic organizers, personal digital assistants (PDAs), smartphones, and any communication apparatus or the like.

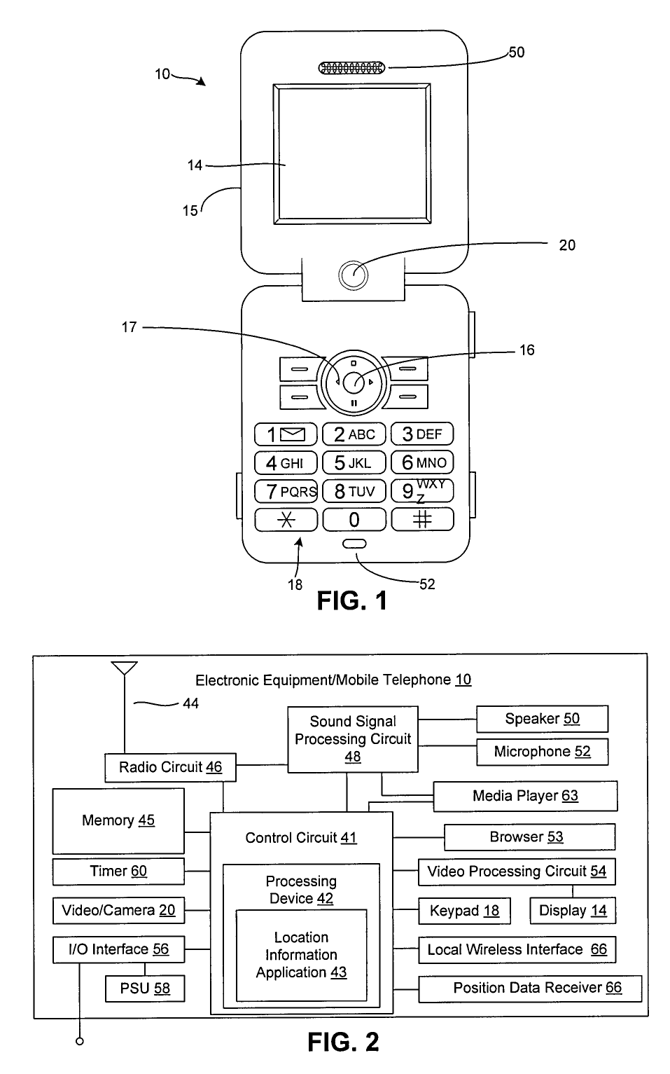

FIG. 1 depicts an exemplary mobile telephone 10. Mobile telephone 10 may be a clamshell phone with a flip-open cover 15 movable between an open and a closed position. In FIG. 1, the cover is shown in the open position. It will be appreciated that mobile telephone 10 may have other configurations, such as a “block” or “brick” configuration.

FIG. 2 represents a functional block diagram of the mobile telephone 10. Mobile telephone 10 may include a primary control circuit 41 that is configured to carry out overall control of the functions and operations of the mobile telephone 10. The control circuit 41 may include a processing device 42, such as a CPU, microcontroller or microprocessor. Among their functions, to implement the features of the present invention, the control circuit 41 and/or processing device 42 may comprise a controller that may execute program code embodied as the location information application 43. It will be apparent to a person having ordinary skill in the art of computer programming, and specifically in application programming for cameras, mobile telephones or other electronic devices, how to program a mobile telephone to operate and carry out logical functions associated with application 43. Accordingly, details as to specific programming code have been left out for the sake of brevity. Also, while the code may be executed by control circuit 41 in accordance with an exemplary embodiment, such controller functionality could also be carried out via dedicated hardware, firmware, software, or combinations thereof, without departing from the scope of the invention.

Referring to FIGS. 1 and 2, mobile telephone 10 has a display 14 viewable when the clamshell telephone is in the open position. The display 14 displays information to a user regarding the various features and operating state of the mobile telephone 10, and displays visual content received by the mobile telephone 10 and/or retrieved from a memory 45. Also, the display 14 may be used as an electronic viewfinder for a video/camera assembly 20. The video/camera assembly 20 may take still photographs or moving video images. It will be appreciated that the precise configuration of the video/camera assembly may vary without departing from the scope of the invention, and the depiction in the figures may be considered an exemplary embodiment.

Mobile telephone 10 has a keypad 18 that provides for a variety of user input operations. For example, keypad 18 typically includes alphanumeric keys for allowing entry of alphanumeric information such as telephone numbers, phone lists, contact information, notes, etc. In addition, keypad 18 typically includes special function keys such as a “send” key for initiating or answering a call, and others. Some or all of the keys may be used in conjunction with the display as soft keys. Keys or key-like functionality also may be embodied as a touch screen associated with the display 14. Keypad 18 also may include a five-way navigational surface 17. The navigational surface 17 may include four directional surfaces and a center “select” button 16 to provide for a variety of navigation and input functions. In one embodiment, the center button 16 may act as a record button to initiate recording a video with the video/camera function 20.

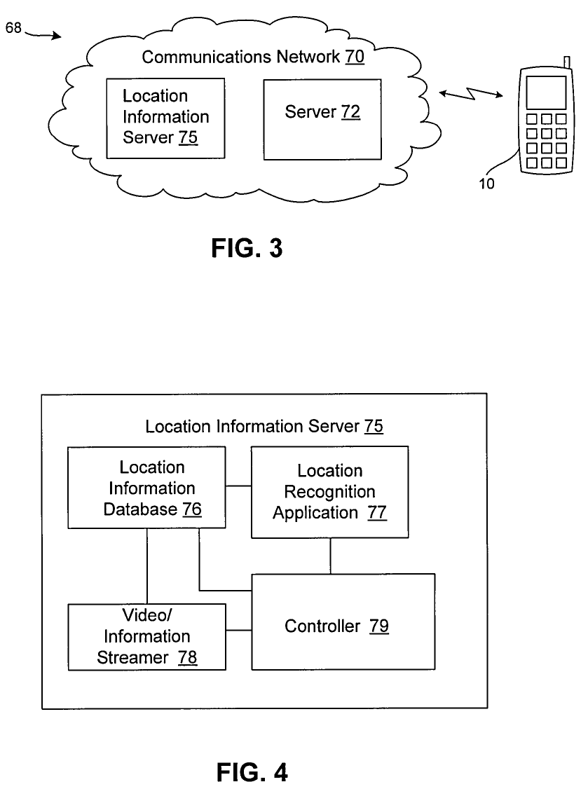

Referring to FIG. 3, the mobile telephone 10 may be configured to operate as part of a communications system 68. The system 68 may include a communications network 70 having a server 72 (or servers) for managing calls placed by and destined to the mobile telephone 10, transmitting data to the mobile telephone 10 and carrying out any other support functions. The server 72 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 70 may support the communications activity of multiple mobile telephones 10 and other types of end user devices. As will be appreciated, the server 72 may be configured as a typical computer system used to carry out server functions and may include a processor configured to execute software containing logical instructions that embody the functions of the server 72 and a memory to store such software.

Communications network 70 also may contain a location information server 75. FIG. 4 represents a functional block diagram of the components of an exemplary location information server 75. The location information server 75 may include a location information database 76 for storing a plurality of datasets pertaining to numerous locations. The datasets may be in the form of webpages or comparable network locations that may be accessible by a user. The user may access the database using, for example, a browser function 53 contained in the portable electronic device (see FIG. 2). The location information server also may include a controller 79 for carrying out and coordinating the various functions of the server. Location information server 75 also may include a location recognition application 77, which, as further described below, may be used to recognize a user's location so that information about the location may be provided to the user from the location information database 76. In addition, location information server 75 may contain a video/information streamer 78 to transmit video or other information directly to a user, as also is further described below.

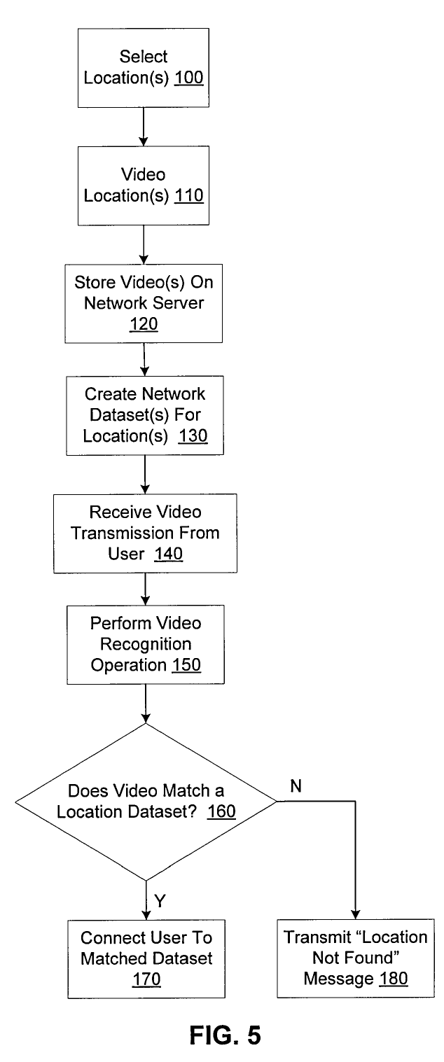

FIG. 5 depicts an exemplary method by which the location information database 76 may be created within the location information server 75 by a service provider. FIG. 5 also depicts how location information may be provided from the location information database to a user. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

Referring to FIG. 5, the method begins at step 100 in which a service provider may select locations to be contained within the location information database. The locations may be tourist sites, retail outlets, restaurants, government offices, or any other location about which an individual may desire specific information. In this embodiment, the locations may be identified using an associated video of the location. Accordingly, at step 110 videos of the locations are taken, and at step 120, the videos are stored within the location information database on the network location information server. At step 130, a network dataset is created for each location. The network datasets may contain detailed information about the selected locations. The datasets may be in the form of one or more webpages or comparable storage form that may be accessible by a user with an Internet or network browser, as is known in the art.

At step 140, the network location information server receives a video transmission from a user. The user may be at a particular location and taking the video, which may be streamed in real time to the server. Alternatively, a user may have taken the video at a previous time and stored the video in a memory within the portable electronic device (or other electronic device such as a computer). At step 150, the location information server performs a location recognition operation. In this embodiment, the location recognition operation is a video recognition operation that attempts to match the user's video against the videos taken by the service provider at step 110. At step 160, the location information server may determine whether the user's video matches an associated video for a location dataset. In this manner, the location of the user may be identified. If a match is found, then at step 170 the user is connected to the dataset for that location. As stated above, the dataset may be in the form of one or more webpages containing information about the location. The user may be connected to the associated webpage(s) by accessing the browser function of the portable electronic device. If at step 160 a match is not found, then at step 180 a “Location Not Found” message may be transmitted to the user's portable electronic device.

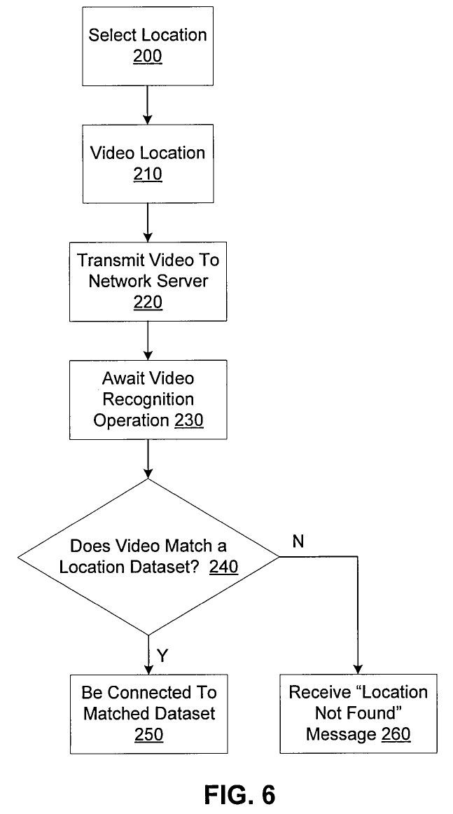

FIG. 6 depicts an exemplary method by which a user may obtain location information from a service provider. Whereas FIG. 5 was described from the service provider's or network point of view, FIG. 6 may be thought of as a comparable method from the user's point of view. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

Referring to FIG. 6, at step 200 a user selects a location about which information is desired. At step 210, the user may take a video of the location, and at step 220, the video may be transmitted to the network location information server. As stated above, the user's video may be taken and streamed in real time, or the video may be uploaded from a file stored in a memory in an electronic device. At step 230, the user may wait while the network server performs the location recognition operation, which in this embodiment is a video recognition operation. At step 240, the determination may be made as to whether the user's video matches a location video stored on the network. If so, at step 250 the user may be connected to the location dataset, such as a webpage(s) associated with the desired location. The user then has access to more detailed information about the location, which is contained in the location dataset, by browsing the webpage(s). If there is no match, at step 260 the user may receive a “Location Not Found” message to the user's portable electronic device.

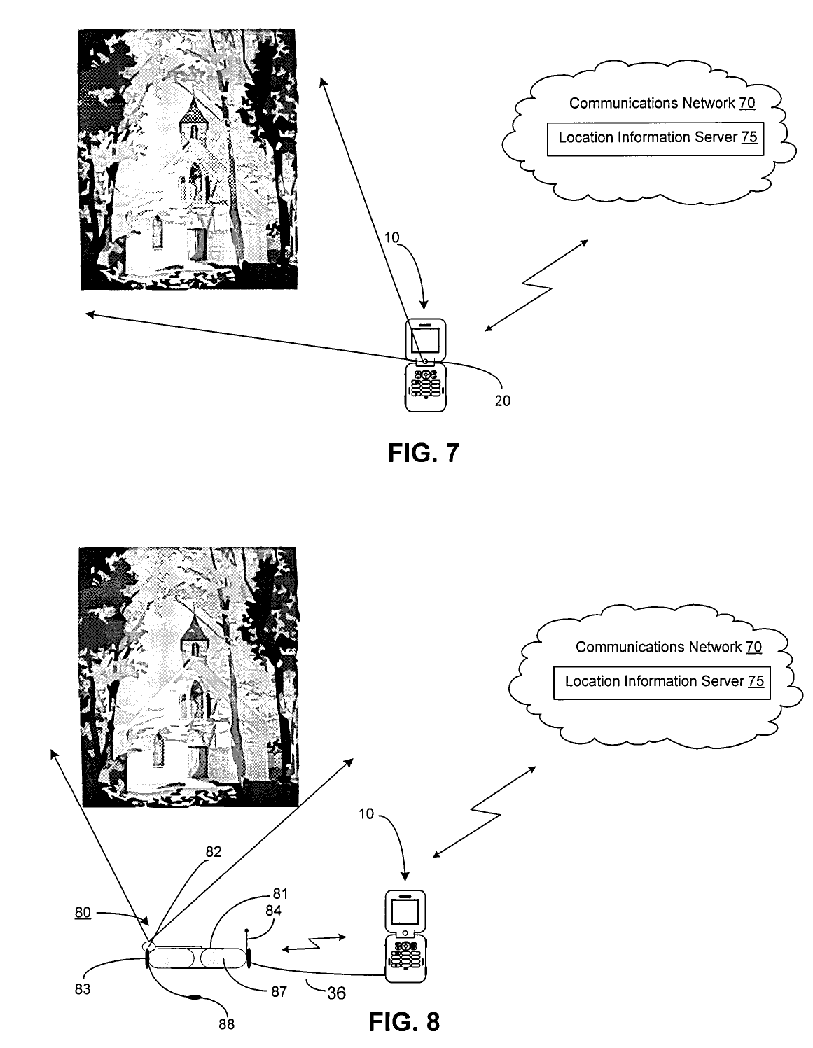

More detailed examples incorporating the above methods will now be described. Referring to FIG. 7, the location of a user is represented by the mobile telephone 10 having a video camera function 20. As indicated by the straight arrows, the user may take a video of the location where the user is present. In this example, the user is located at a church. It will be appreciated that the location may be any site about which a user may desire information. The location may be a tourist site, retail store, restaurant, office or government building, etc. As indicated by the jagged arrow, the video may be transmitted over the communications network 70 to the location information server 75.

Referring again to FIGS. 2 and 4, as stated above, executable code may be resident within the mobile telephone 10 in the form of location information application 43. Application 43 may be embodied within a controller (as depicted in FIG. 2), or constitute a separate application stored in memory. Application 43 may be selected by the user from a menu as is conventional. In one embodiment, when application 43 is selected, a video taken with the video/camera 20 is automatically streamed or otherwise transmitted to the location information server 75. The location information server may include location recognition application 77, which attempts to match the user's transmitted information to information contained in the location information database 76 to identify the user's location. In this embodiment, the location recognition application 77 performs a video recognition algorithm, as is known in the art, to determine whether the user transmitted video matches any of the location videos contained in the location information database 76. If the location recognition application 77 determines that there is a match, then the user is connected to the location dataset for that location. In one embodiment, the location dataset is one or more webpages contained in the location information database 76. The connection may be attained using the browser function 53 of the mobile telephone 10. Browser 53 may be any known browser for accessing network data or web information, such as an Internet browser, and may be a stand-alone device function of mobile telephone 10 (see FIG. 2) or incorporated as part of the location application 43.

Once connected to the location webpage, the user may view and/or listen to information about the location. For example, information about the church may include hours of services or visitation, history, contact information and/or other information a visitor may desire about the church. Other types of locations may be associated with one or more webpages in a similar fashion. For example, business entities may provide information about their products and services, hours of operation, pricing, etc. Tourist site webpages additionally may contain historical information. A theater webpage may contain details about various shows and performance times, and so on. It will be appreciated that datasets for various other location categories may be employed.

In one embodiment, individual users may contribute to the network information database 76. For example, a user may video a location or object for which the user desires to create a webpage. The user may then upload the video to the network information database 76, along with additional information to be included on one or more webpages to be associated with the location or object. Other users may then access the webpage(s) in the manner described above. For example, suppose a user wishes to place a home on the market for sale. The seller may take a video of the home and transmit the video to the location information server to become part of the location information database. The seller also may create an associated webpage containing information about the home. A potential buyer may take a video of the home, which may then be transmitted to the location information server 75. The location recognition application 77 may perform the video recognition algorithm, as described above, to match the buyer's video to the seller's video on the database. The buyer may then be connected to the seller's webpage associated with the home. Other user-defined webpages may be developed and accessed by other users in a similar fashion.

FIG. 8 depicts an alternative embodiment in which the system of the present invention includes a head mounted display (HMD). The HMD includes a frame portion 81, which houses the various components. An exemplary frame portion may be comparable to an eyeglass configuration which may be worn about the user's head, although other configurations may be employed. The HMD also may include audio headset features, such as earphones 83 and a microphone 88, which may be used for conversing in a telephone calling mode. The HMD also may include one or more displays 87, which are mounted to the frame 81 in a manner that substantially corresponds to an eyeglass configuration. The configuration permits regular vision as well as displaying information to the user. The HMD also may include a video camera 82 for taking a video of the user's location in accordance with exemplary embodiments of the present invention, as indicated by the straight arrows. When the HMD includes audio or calling features, the HMD may have an antenna 84 for communication with other electronic devices. For example, as indicated by the smaller jagged arrow, the HMD may communicate with a portable electronic device, such as the mobile telephone 10, over a short distance wireless interface. The wireless interface may be a Bluetooth, RF, infrared, or other wireless interface as are known in the art. In addition, for high-resolution video, the HMD may have a wired connection 36 for connection to an I/O interface 56 on the mobile telephone (see FIG. 2). The video connection may be VGA, component, digital video interface (DVI) or other video connections as are known in the art. In addition, as the resolution of wireless streaming video has improved, it alternatively may be possible to stream video between the HMD and the mobile telephone.

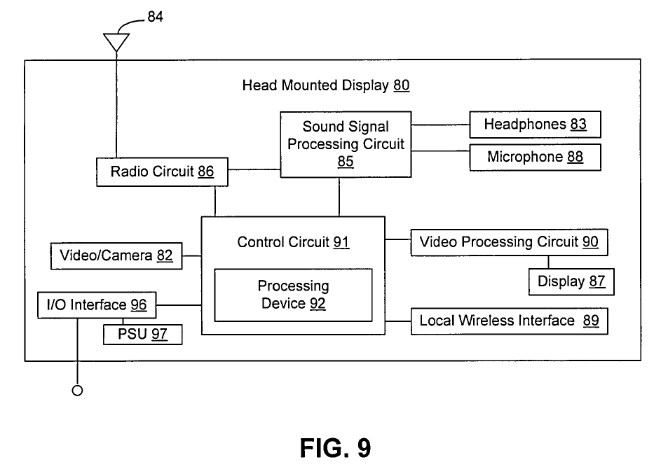

FIG. 9 represents a functional block diagram of the HMD 80. The antenna 84 may be coupled to a radio circuit 86. For an HMD also having audio calling capabilities, the radio circuit 86 includes a radio frequency transmitter and receiver for transmitting and receiving signals via the antenna 84 as is conventional. The HMD 80 further includes a sound signal processing circuit 85 for processing audio signals transmitted by and received from the radio circuit 86. Coupled to the sound processing circuit 85 are the earphones 83 and microphone 88. The displays 87 may be coupled to a video processing circuit 90 that converts video data to a video signal used to drive the various displays. Video/camera 82 may be used to video the user's location. A local wireless interface 89, such as a Bluetooth, RF, infrared, or other short distance interface, may be used to transmit and receive data from other electronic devices, as is conventional. The HMD also may contain a control circuit 91, which may include a processing device 92, which controls overall operation of the HMD.

The HMD also may include and I/O interface 96. As one function, the I/O interface may permit a wired video connection to a portable electronic device, as described above. In addition, the I/O interface may include a power connection to a power supply unit 97. In situations in which the HMD is fully wireless, the PSU may include a rechargeable battery feature. It will be appreciated that the precise HMD structure is not intended to limit the scope of the invention. Other HMD configurations may be employed.

When using the HMD in an exemplary embodiment of the invention, as shown in FIG. 8, a user may video a location using the video/camera function 82. The video may first be transmitted to the mobile telephone 10 over the wired video connection, and then be transmitted to the location information server 75 on the network 70. As described above, the location information server may then perform the video recognition algorithm to attempt to identify and match the user's location. If the user's location matches a location encompassed by the location database, the user may then be connected to a webpage(s) corresponding to the location. Information contained on the webpage(s) may be displayed on the display 14 of the mobile telephone, or be transmitted over the video connection interface to the HMD for display on the HMD displays 87.

In the previous embodiments, the user ultimately is connected to a webpage or comparable location dataset containing more specific information about the location. The user may then use a conventional browser function to navigate the webpage to access the various specific items of information. Alternatively, instead of using a browser, the information may be transmitted directly to the user from the location information database.

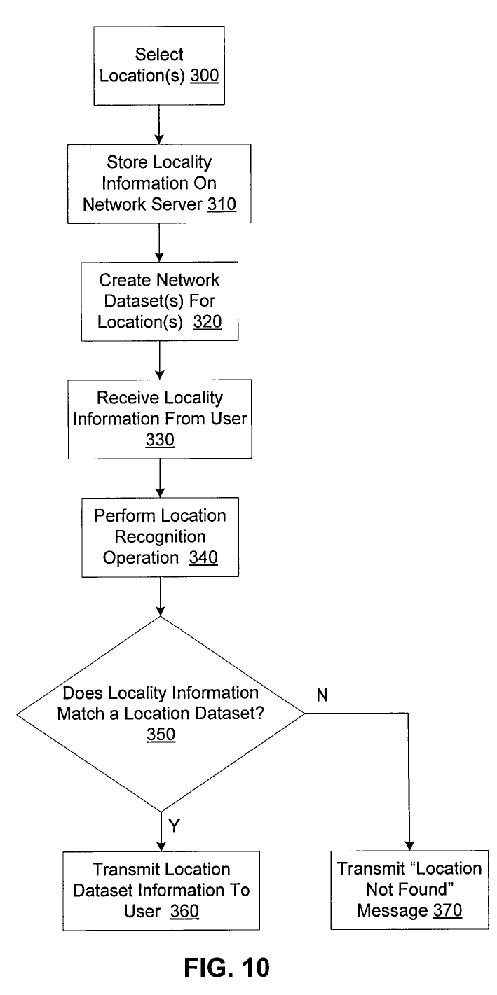

FIG. 10 depicts another exemplary method by which a location information database may be created within a location information server. FIG. 10 also depicts how the location information may be transmitted directly from the location information database to a user. FIG. 10 may be thought of as a comparable but alternative direct transmission method to FIG. 5. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

Referring to FIG. 10, at step 300 a plurality of locations may be selected for inclusion in a network location information database. At step 310, “locality information” may be stored on the network location information server. As used herein, the term “locality information” refers to information independent of coordinates data and sufficient to identify the location. At step 320, a network location dataset is created for each selected location comprising more detailed information about each location. As before, the location datasets may be created by a network service provider, and/or by individual users who may upload information to the network about locations they wish to publicize.

At step 330, the location information server may receive a transmission of locality information from a user corresponding to the user's location. At step 340, the location information server may perform a location recognition operation on the user's locality information to attempt to identify and match the location of the user. At step 350, the location information server may determine whether the user's locality information matches the locality information for an associated location dataset. If a match is found, then at step 360 the server transmits the location dataset information directly to the user. If at step 350 a match is not found, then at step 370 a “Location Not Found” message may be transmitted to the user.

As with previous embodiments, the network functions may be performed using the location information server 75 depicted in FIG. 4. Again, the locality information and corresponding location datasets may be stored in the location information database 76. When locality information is received from a user, the location recognition application 77 may determine whether the user's locality information matches the locality information of a location dataset stored in the location information database. If so, video/information streamer 78 may then transmit the detailed location information directly to the user. The location information may consist of text, sound, pictures, moving images, or combinations thereof.

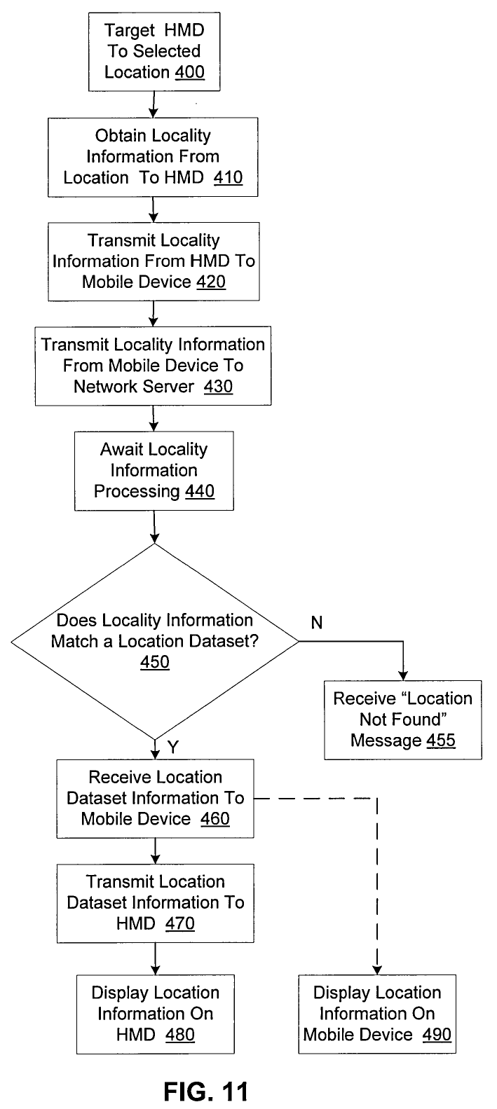

FIG. 11 depicts an exemplary method by which a user may obtain location information directly from a service provider. Whereas FIG. 10 was described from the service provider's point of view, FIG. 11 may be thought of as a comparable method from the user's point of view. In this vein, the method of FIG. 11 also may be thought of as a comparable but alternative direct transmission method to FIG. 6. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The exemplary method of FIG. 11 incorporates the use of an HMD. It will be appreciated that comparable steps may be performed using a portable electronic device without using the HMD. At step 400, a user may target the HMD, as is further described below, toward a selected location about which information is desired. At step 410, the user may obtain locality information from the location, as also will be further described below. At step 420, the locality information may be transmitted over a short distance wireless interface to a user's mobile device, such as a mobile telephone, and at step 430 the locality information may be transmitted from the mobile device to the network server. At step 440, the user waits while the network server processes the locality information to attempt to recognize and match the user's location.

At step 450, the determination may be made as to whether the user's locality information matches the locality information of a location dataset stored on the network. If there is no match, at step 455 the user may receive a “Location Not Found” message to the user's portable electronic device. If a match is found, at step 460 the user may receive location dataset information directly to the user's mobile device from the network. At step 470, the location information may be transmitted to the HMD and displayed thereon at step 480. Alternatively, as shown by the dashed line, at step 490 the location dataset information may be displayed on a display on the mobile device. Again, the location dataset information may be detailed information about the location, such as text, sound, pictures, moving images, or combinations thereof.

More detailed features and examples employing the methods of FIGS. 10 and 11 will now be described. As stated above, the locality information constitutes information independent of coordinates data and sufficient to identify the location. In one embodiment, the locality information may include location identifiers such as a name, description, physical features and/or others to identify the location. In this embodiment, the locality information does not include coordinates information, such as GPS coordinates. The locality information may provide accurate location identification for a variety of situations. For example, suppose a user is in a shopping mall or a multi-story office building. At such a location, numerous separate entities may be in too close proximity for GPS coordinates alone to distinguish between locations. In another situation, a user may be at a chain location that is similar in name and appearance to other locations of the chain, as may be, for example, the case with a chain retailer or restaurant. The location identifiers in these situations are sufficiently specific to distinguish even among similar locations.

In other embodiments, the locality information may further include location coordinates information in combination with the above location identifiers. The coordinates may be provided by a position data receiver 66 with the mobile telephone 10, or mounted at the location. The position data receiver may be a GPS device or other location finder as is known in the art.

Locality information may be obtained from the location in a variety of means. For example, referring again to FIG. 8, a user may take a video of the location. The video may be combined with GPS coordinates obtained from a position data receiver, contained within either the user's mobile device or mounted on the location. Similar to previous embodiments, a video recognition algorithm may be performed by the network server as part of the process of matching the user's locality information to a network location dataset.

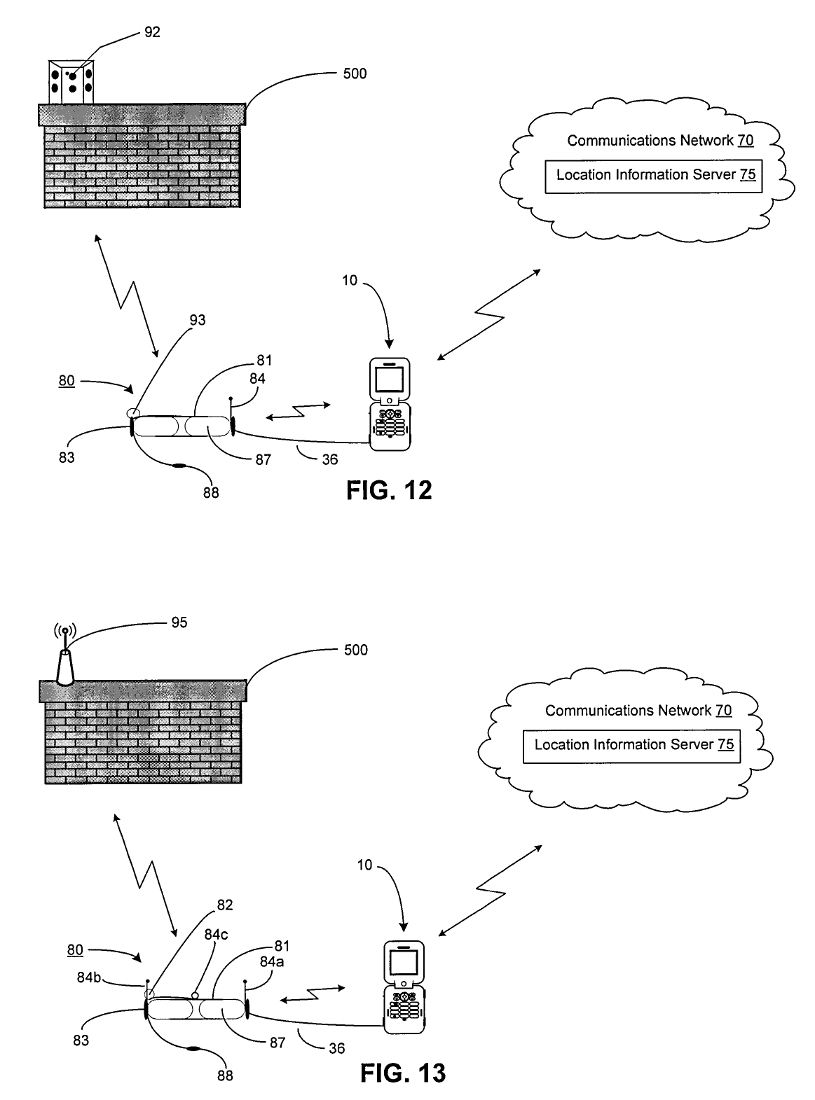

FIG. 12 provides an alternative exemplary method of obtaining locality information using an LED signal transmission. The use of LEDs to transmit coded data is known in the art. In FIG. 12, the location 500 is represented by a wall. It will be appreciated that the location 500 may be any store, restaurant, office, tourist site, etc. An LED signal transmitter 92 for transmitting coded locality information is mounted on the location 500. It will be appreciated that FIG. 12 is a schematic representation and does not necessarily depict the precise configuration of the LED signal transmitter. Those skilled in the art will understand how to configure the LEDs to transmit the appropriate information. The LED signal transmitter may be incorporated into the location's ordinary lighting system, or may be provided as a separate device. Various configurations may be employed.

An LED signal receiver 93 may be mounted on the HMD to receive the LED signal information. As shown in FIG. 12, the LED signal receiver may be incorporated into the camera of the HMD. Alternatively, the LED signal receiver may be incorporated into other components, such as the antenna 84, or be a stand-alone component. The LED signal receiver may be a photodetector for receiving light-transmitted signals. If multiple locations in close proximity may be transmitting LED locality information, a user may distinguish among various locations simply by facing the HMD toward the desired location so that the strongest signal received by the HMD may be recognized. Once the LED locality information is received by the HMD, the locality information may be relayed via the mobile telephone 10 to the network location information server 75. The LED information may be decoded by location information application 43 located in the mobile telephone 10 (see FIG. 2), or as part of the location recognition operation performed by the network location recognition application 77 (see FIG. 4).

FIG. 13 provides an alternative exemplary method of obtaining locality information using a radio frequency (RF) transmission. In this embodiment, a radio transmitter 95 for transmitting locality information is mounted on the location 500. The HMD may employ multiple antennae to distinguish among radio transmissions of locality information by various locations in close proximately. It is known in the art that multiple radio antennae may be used to determine the orientation of an object. In one embodiment, the HMD has a multiple antennae configuration including antennae 84a, 84b, and 84c with one antenna adjacent to each earphone and one antenna located toward the front of the HMD. It will be appreciated that as a user turns his head, the distance between a radio source and each antenna will change. In this manner, the orientation of the user may be determined. The third antenna 84c may be offset from a geometric plane containing antennae 84a and 84b. As shown in FIG. 13, antenna 84c may be mounted more toward the front of the user. Thus, antenna 84c would be closer to a radio source when the user faces toward the source, and antenna 84c would be farther from the radio source when the user faces away. In this manner, the system may be configured to distinguish locality information from a source directly in front of the user from a source directly behind. Thus, the system may be configured so that only locality information will be processed when it is received from a radio source toward which the user is facing.

In one embodiment, the system may be equipped with a lock-on feature. Once the user selects and targets a location about which information is desired, the user may provide an indication to lock out other locations. For example, the user may depress the button 16 of keypad 18 (see FIG. 1) to lock out other locations. Now, should the user move his head, thereby altering the orientation of the HMD, the user still will receive information about the originally selected location.

The categories of information that may be provided to a user of a portable electronic device are myriad. As to any location, the location information dataset may include hours of operation and a description of the location. Retailers and restaurants may provide information regarding product availability, pricing, and special promotions. The information also may be updated as the products, pricing, and promotions change. Tourist sites may provide historical information, and service businesses and government offices may provide information about their available services. Individuals may use this system for posting information relating to private buying and selling opportunities, or as a means of sharing information, such as photographs and videos, with family and friends. Other categories of information also may be provided.

In other embodiments, the location information datasets may include sub-datasets accessible by the user. In this manner, a user may be able to obtain information about specific items being viewed at a location. For example, suppose a user is at retail outlet. In accordance with the above embodiments, the user may obtain general information about the retailer, such as its hours of operation and special promotions. The location dataset for the retailer also may contain sub-datasets with more specific information, such as prices of particular items. As the user walks the aisles, the user may target a portable electronic device or HMD to a specific item for sale. Item information may be obtained by the user in accordance with one of the embodiments above, such as by video, LED signal transmission, or RF transmission. The item information may then be transmitted to the network server storing the location information database. The server may identify the item, and transmit pricing or other product information to the user. In a comparable manner, information about specific items at any location may be obtained.

In certain circumstances, LED or RF signal transmissions may be capable of transmitting substantially more data than the mere locality information. For example, an LED or RF signal transmission may be capable of transmitting detailed information about the location, such as the text, sound, pictures, and/or images as might otherwise be stored within the network location information database. In such situations, the network server may not be necessary. Instead, all the information about the location may be transmitted directly from the location, via the LED or RF signal transmission, to the user.

Referring again to FIG. 2, additional features of the mobile telephone 10 will now be described. For the sake of brevity, generally conventional features of the mobile telephone 10 will not be described in great detail herein. The mobile telephone 10 includes call circuitry that enables the mobile telephone 10 to establish a call and/or exchange signals with a called/calling device, typically another mobile telephone or landline telephone, or another electronic device. The mobile telephone 10 also may be configured to transmit, receive, and/or process data such as text messages (e.g., colloquially referred to by some as “an SMS,” which stands for short message service), electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in the memory 45, executing applications to allow user interaction with data, displaying video and/or image content associated with the data, outputting audio sounds associated with the data and so forth.

The mobile telephone 10 may include an antenna 44 coupled to a radio circuit 46. The radio circuit 46 includes a radio frequency transmitter and receiver for transmitting and receiving signals via the antenna 44 as is conventional. The mobile telephone 10 further includes a sound signal processing circuit 48 for processing audio signals transmitted by and received from the radio circuit 46. Coupled to the sound processing circuit 48 are a speaker 50 and microphone 52 that enable a user to listen and speak via the mobile telephone 10 as is conventional.

The display 14 may be coupled to the control circuit 41 by a video processing circuit 54 that converts video data to a video signal used to drive the various displays. The video processing circuit 54 may include any appropriate buffers, decoders, video data processors and so forth. The video data may be generated by the control circuit 41, retrieved from a video file that is stored in the memory 45, derived from an incoming video data stream received by the radio circuit 48 or obtained by any other suitable method.

The mobile telephone 10 also may include a media player 63. The media player 63 may be used to present audiovisual content to the user which may include images and/or sound together or individually, such as photographs or other still images, music, voice or other sound recordings, movies, mobile television content, news and information feeds, streaming audio and video, and the like.

The mobile telephone 10 also may include an I/O interface 56 that permits connection to a variety of I/O conventional I/O devices. One such device is a power charger that can be used to charge an internal power supply unit (PSU) 58.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A system for obtaining location information comprising:
a user electronic device comprising a locality information receiver for obtaining locality information, independent of location coordinates data and sufficient to identify a user's location;
a location information database containing locality information corresponding to and sufficient to identify a plurality of locations about which information is stored in the database; and
a controller configured to compare the locality information for the user's location to the locality information stored on the location information database to determine whether the user's locality information matches the locality information of one of the plurality of locations, wherein if a match is found, the controller causes information about the matched location to be transmitted from the location information database to the user electronic device.

2. The system according to claim 1, wherein the locality information receiver is a video camera and the locality information of the user's location is a video of the location taken with the video camera;
the locality information stored on the location information database comprises videos of the plurality of locations about which information is stored in the database; and
wherein the controller is configured to perform video recognition to compare the video of the user's location to the videos stored on the location information database to determine whether the user's location matches one of the plurality of locations encompassed by the database.

3. The system according to claim 2 further comprising a second user electronic device having a video camera, wherein at least one of the location videos stored on the location information database is a video taken using the second user electronic device.

4. The system according to claim 1 further comprising an LED signal transmitter at the user's location;
wherein the locality information receiver is an LED signal receiver and the locality information is included in an LED signal transmission received from the LED signal transmitter; and
wherein the controller is configured to ascertain the locality information from the LED signal transmission to compare the locality information for the user's location to the locality information stored on the location information database.

5. The system of claim 1 further comprising a radio transmitter at the user's location;
wherein the locality information receiver is a radio receiver and the locality information is included in a radio transmission received from the radio transmitter; and
wherein the controller is configured to ascertain locality information from the radio transmission to compare the locality information for the user's location to the locality information stored on the location information database.

6. The system of claim 1, wherein the user electronic device further comprises a display for displaying the information transmitted from the location information database.

7. The system of claim 1, wherein the user electronic device further comprises a browser, and the user electronic device receives information from the location information database by browsing the location information database.

8. The system of claim 1, wherein the controller is configured to stream information from the location information database to the user electronic device.

9. The system of claim 1 further comprising a server remote from the user electronic device, wherein the server contains at least one of the location information database and the controller.

10. The system of claim 1, wherein the user electronic device comprises a portable electronic device.

11. The system of claim 10, wherein the user electronic device further comprises a head mounted display in communication with the portable electronic device, and the locality information receiver is mounted on the head mounted display.

12. The system of claim 10, wherein the portable electronic device is a mobile telephone.

13. The system of claim 1, wherein the locality information further includes GPS coordinates data.

14. A method of obtaining information with a user electronic device about a location comprising the steps of:
selecting a location about which information is desired;
obtaining locality information, independent of location coordinates data, with the user electronic device sufficient to identify the selected location;
comparing the locality information of the selected location with locality information corresponding to a plurality of locations about which information is stored in a location information database to determine whether the locality information of the selected location matches the locality information of one of the plurality of locations; and
receiving information with the user electronic device about a matched location from the location information database.

15. The method of claim 14, wherein locality information is obtained by taking a video of the selected location, and the comparing step is performed by using a video recognition algorithm to determine if the video of the selected location matches a video stored on the location information database of one of the plurality of locations.

16. The method of claim 14, wherein the locality information is obtained by receiving an LED signal transmission containing the locality information, and the comparing step comprises ascertaining the locality information from the LED signal transmission.

17. The method of claim 14, wherein the locality information is obtained by receiving a radio transmission containing the locality information, and the comparing step comprises ascertaining the locality information from the radio transmission.

18. The method of claim 14, wherein the receiving step comprises connecting to a webpage in the location information database containing information about the selected location, and browsing the webpage.

19. The method of claim 14, wherein the locality information is obtained using a head mounted device.

20. The method of claim 14, wherein the receiving step comprises receiving a streaming information transmission from the location information database.

21. The method of claim 14, further comprising displaying the received information.

22. The method of 21, wherein the received information is displayed on a head mounted display.

23. A method of providing location information to a user electronic device comprising:
selecting a plurality of locations about which information may be provided;
storing locality information, independent of location coordinates data, for and sufficient to identify each of the plurality of locations on a location information database;
receiving locality information from a user electronic device, independent of location coordinates data and sufficient to identify a user's location;
comparing the locality information received from the user electronic device with the locality information corresponding to the plurality of locations about which information is stored on the location information database to determine whether the locality information of the user's location matches the locality information of one of the plurality of locations; and
transmitting information to the user electronic device about a matched location from the location information database.

24. The method according to claim 23, wherein the transmitting step comprises streaming information about a matched location to the user electronic device.

25. The method according to claim 23, wherein the locality information for the user's location and the plurality of locations about which information is stored on the location information database are videos of the locations, and the comparing step comprises performing a video recognition algorithm to determine whether the user's location matches one of the plurality of locations.
